(19) United States
(12) Patent Application Publication
(10) Pub. No.: US 2025/0148324 A1
(43) Pub. Date: May 8, 2025

(54) Counterfactuals Based Automated Decision System

(71) Applicant: Charter Communications Operating, LLC, St. Louis, MO (US)

(72) Inventors: Srilal M. WEERASINGHE, Parker, CO (US); Michelle R. HURT, Centennial, CO (US); Vipul PATEL, Parker, CO (US); Keshav M. CHANNARAYAPPA, Colorado Springs, CO (US); Virginia WILLETT, Lone Tree, CO (US)

(21) Appl. No.: 18/500,965

(22) Filed: Nov. 2, 2023

(51) Int. Cl. G06N 5/045

(52) U.S. Cl. CPC G06N 5/045

(57) ABSTRACT

Various embodiments include systems and methods for using artificial intelligence (AI) to make decisions or predictions without direct human intervention. A computing device may be configured to receive an input query that includes query parameters and auxiliary data, apply the received input query to an AI model to generate an initial prediction, and perform explainable AI (XAI) analysis using approximate methods to identify influential features. The computing device may determine key features based on the identified influential features, apply the determined key features to a modified counterfactual model to generate an initial set of counterfactuals, prioritize the generated initial set of counterfactuals, and determine whether the prioritized set of counterfactuals has reached convergence. The computing device may output an enhanced set of counterfactuals in response to determining that the prioritized set of counterfactuals has reached convergence.

### BACKGROUND

Recent privacy regulations, such as the California Consumer Privacy Act (CCPA) and the General Data Protection Regulation (GDPR) in the European Union, advocate for increased transparency in automated decision-making systems. These regulations may promote a consumer's ‘right to an explanation’ and mandate that individuals be able to understand how decisions affecting them are made. Concurrent with these trends, recent advancements in artificial intelligence (AI) and machine learning (ML) technologies have led to the development of increasingly complex and sophisticated models that make providing such explanations a significant technical challenge for the technology industry.

Artificial Intelligence (AI) is a broad field of computer science that focuses on creating systems capable of performing tasks that would ordinarily require human intelligence. These tasks include, but are not limited to, problem-solving, language understanding, learning, perception, and decision-making. AI aims to replicate or simulate a wide range of human cognitive functions. Various approaches to achieving AI's goals include rule-based systems, expert systems, neural networks, and natural language processing, among others.

Machine Learning (ML) is a specialized subset of AI that concentrates on developing algorithms and statistical models that enable computers to perform a task without explicitly being programmed for that task. In other words, ML provides a system with the ability to learn from data.

### SUMMARY

Various aspects include methods performed by a computing device for using artificial intelligence (AI) to make decisions or predictions without direct human intervention, which may include receiving an input query that may include query parameters and auxiliary data, applying the received input query to an AI model to generate an initial prediction, performing explainable AI (XAI) analysis using approximate methods to identify influential features, determining key features based on the identified influential features, applying the determined key features to a modified counterfactual model to generate an initial set of counterfactuals, prioritizing the generated initial set of counterfactuals, determining whether the prioritized set of counterfactuals has reached convergence, and outputting an enhanced set of counterfactuals in response to determining that the prioritized set of counterfactuals has reached convergence.

Some aspects may further include performing validation analysis on the query parameters to determine conformance to a standard or constraint or to ensure that the input query and its subsequent results follow predefined validation rules and guidelines. In some aspects, performing XAI analysis using approximate methods to identify influential features may include creating a new dataset by perturbing features of the generated initial predictions that need to be explained, using a trained machine learning model to make predictions on the perturbed samples, assigning weights to the perturbed samples based on their similarity to the generated initial predictions, and apply a linear regression model to the perturbed samples using the assigned weights.

In some aspects, applying the determined key features to a modified counterfactual model to generate the initial set of counterfactuals may include applying the determined key features to a counterfactual model with relaxed sparsity to generate the initial set of counterfactuals. In some aspects, applying the determined key features to a modified counterfactual model to generate the initial set of counterfactuals may include applying the determined key features to the modified counterfactual algorithm to identify alternative less-sensitive queries and generate a list of alternative queries that are compliant with California Consumer Privacy Act (CCPA) or General Data Protection Regulation (GDPR). In some aspects, applying the determined key features to a modified counterfactual model to generate the initial set of counterfactuals may include applying the determined key features to the modified counterfactual algorithm to generate counterfactuals with different combinations of categorical data types.

Further aspects may include a computing device having a processing system configured with processor-executable instructions to perform various operations corresponding to the methods summarized above. Further aspects may include a non-transitory processor-readable storage medium having stored thereon processor-executable instructions configured to cause a processing system to perform various operations corresponding to the method operations summarized above. Further aspects may include a computing device having various means for performing functions corresponding to the method operations summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 illustrates an example computing system architecture that may be used in a computing system implementing the various embodiments.

FIG. 2 illustrates example components that could be included in a computing device that implements an automated decision system (ADS) configured to implement the various embodiments.

FIGS. 3 and 4 are process flow diagrams illustrating methods of generating enhanced counterfactuals (e.g., for improved queries, combinatorial optimization, ad campaign optimization, data clean room, etc.) in accordance with some embodiments.

FIG. 5 is a process flow diagram illustrating a method of enhancing database queries within multi-dimensional feature spaces in accordance with some embodiments.

FIG. 6 is a component diagram of an example server suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

The term “service provider network” is used generically herein to refer to any network suitable for providing consumers with access to the Internet or IP services over broadband connections and may encompass both wired and wireless networks/technologies. Examples of wired network technologies and networks that may be included within a service provider network include cable networks, fiber optic networks, hybrid-fiber-cable networks, Ethernet, local area networks (LAN), metropolitan area networks (MAN), wide area networks (WAN), networks that implement the data over cable service interface specification (DOCSIS), networks that utilize asymmetric digital subscriber line (ADSL) technologies, satellite networks that send and receive data etc. Examples of wireless network technologies and networks that may be included within a service provider network include third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), high-speed downlink packet access (HSDPA), 3GSM, general packet radio service (GPRS), code division multiple access (CDMA) systems (e.g., cdmaOne, CDMA2000™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), Bluetooth®, land mobile radio (LMR), and integrated digital enhanced network (iden). Each of these wired and wireless technologies involves, for example, the transmission and reception of data, signaling and/or content messages. Any references to terminology and/or technical details related to an individual wired or wireless communications standard or technology are for illustrative purposes only, and not intended to limit the scope of the claims to a particular communication system or technology unless specifically recited in the claim language.

The terms “computing device,” “user device” and “user equipment” (UE) may be used generically and interchangeably herein to refer to a broad range of devices such as, but not limited to, satellite or cable set-top boxes (STBs), laptop computers, rack-mounted computers, routers, cellular telephones, smartphones, portable multimedia players, personal digital assistants (PDAs), customer-premises equipment (CPE), tablet computers, smart books, palm-top computers, electronic mail receivers with wireless capability, multimedia-enabled mobile phones, wireless gaming controllers, streaming media devices (for example, devices similar to ROKU™), smart televisions, digital video recorders (DVRs), modems, network switches, residential gateways (RG), access nodes (AN), bridged residential gateways (BRG), products designed for fixed-mobile convergence, home networking adapters, and Internet access gateways. These devices commonly feature a programmable processor, memory, and circuitry for providing the functionality described herein.

The terms “component,” “system,” “engine,” “validator,” “modifier” and the like may be used herein to refer to a computer-related entity (e.g., hardware, firmware, a combination of hardware and software, software, software in execution, etc.) that is configured to perform particular operations or functions. For example, a component may be but is not limited to a process running on a processor, a processor, an object, an executable, a thread of execution, a program, and/or a computing device. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer-readable media having various instructions and/or data structures stored thereon. Components may communicate by way of local and/or remote processes, function or procedure calls, electronic signals, data packets, memory read/writes, and other known computer, processor, and/or process-related communication methodologies.

The term “processing system” is used herein to refer to one or more processors, including multi-core processors, that are organized and configured to perform various computing functions. Various embodiment methods may be implemented in one or more of multiple processors within a processing system as described herein. That is, a computing device configured to implement the features described herein may include one or more processors within a processing system. The computing device may include or may be part of a system-on-chip (SOC), which may include multiple resources, possibly including specialized processors like network processors, digital signal processors, or video processors. These specialized processors might be accompanied by memory blocks and other resources for efficient operation. The SoC may include software for controlling these integrated resources, as well as for managing peripheral devices.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system also may include software for controlling integrated resources and processors, as well as for controlling peripheral devices.

The term “neural network” is used herein to refer to an interconnected group of processing nodes (e.g., neuron models, etc.) that collectively operate as a software application or process that controls a function of a computing device or generates a neural network inference. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and activation. The weight values may be determined during training and iteratively updated as data flows through the neural network.

Deep neural networks implement a layered architecture in which the activation of a first layer of nodes becomes an input to a second layer of nodes, the activation of a second layer of nodes becomes an input to a third layer of nodes, and so on. As such, computations in a deep neural network may be distributed over a population of processing nodes that make up a computational chain. Deep neural networks may also include activation functions and sub-functions (e.g., a rectified linear unit that cuts off activations below zero, etc.) between the layers. The first layer of nodes of a deep neural network may be referred to as an input layer. The final layer of nodes may be referred to as an output layer. The layers in between the input and final layer may be referred to as intermediate layers, hidden layers, or black-box layers.

Each layer in a neural network may have multiple inputs, and thus multiple previous or preceding layers. Said another way, multiple layers may feed into a single layer. For ease of reference, some of the embodiments are described with reference to a single input or single preceding layer. However, it should be understood that the operations disclosed and described in this application may be applied to each of multiple inputs to a layer as well as multiple preceding layers.

The term “convolutional neural network” (CNN) may be used herein to refer to a deep neural network in which the computation in at least one layer is structured as a convolution. A convolutional neural network may also include multiple convolution-based layers, which allows the neural network to use a very deep hierarchy of layers. In convolutional neural networks, the weighted sum for each output activation is computed based on a batch of inputs, and the same matrices of weights (called “filters”) are applied to every output. These networks may also implement a fixed feedforward structure in which all the processing nodes that make up a computational chain are used to process every task, regardless of the inputs. In such feed-forward neural networks, all of the computations are performed as a sequence of operations on the outputs of a previous layer. The final set of operations generates the overall inference result of the neural network, such as a probability that an image contains a specific object (e.g., a person, cat, watch, edge, etc.) or information indicating that a proposed action should be taken.

The term “graph neural network” (GNN) may be used herein to refer to a type of neural network designed to process data structured as graphs. Traditional neural networks, such as convolutional or recurrent neural networks, often assume data inputs like images or sequences, respectively. However, many real-world problems involve data in the form of graphs, representing relationships and interactions among entities, such as social networks, molecular structures, or transportation systems. GNNs extend deep learning techniques to graph-structured data by incorporating mechanisms to propagate information through nodes and edges of a graph. This may allow GNNs to capture complex patterns and dependencies inherent in graph data. Due to their ability to handle irregular structures and relational information, GNNs have gained popularity in recent years in various applications, from molecular chemistry to recommendation systems and social network analysis.

The term “inference” may be used herein to refer to a process that is performed at runtime or during the execution of the software application program corresponding to the neural network. Inference may include traversing the processing nodes in the neural network along a forward path to produce one or more values as an overall activation or overall “inference result.”

The term “classifier” may be used herein to refer to an AI model and/or information structures that may be used by a device processor to evaluate collected data or a specific feature (or factor, condition, data point, operation, component, etc.). For example, a classifier may include decision nodes (e.g., neural networks, decision stumps, boosted decision trees, etc.) that each include a weight value and a test question/condition suitable for evaluating the collected data.

The terms “counterfactual explanations” (CE) and “counterfactuals” may be used interchangeably herein to refer to information structures (e.g., string vectors, etc.) or constructs that suggest alternative results for a scenario by suggesting slight alterations to input attributes. At their core, counterfactuals may highlight which input modifications might result in a divergent outcome from the AI/ML system to shed light on the reasoning behind model predictions and transform opaque models into transparent ones. Counterfactuals may provide a “what-if” analysis allowing a deeper understanding of model predictions. For example, within an automated decision model, understanding how minor tweaks to certain inputs could yield a different conclusion becomes evident through counterfactuals. This interpretative approach elucidates how predictions might vary based on specific conditions. The essence of counterfactuals is to pinpoint the subtlest adjustments in input attributes that would prompt a distinct prediction from the model. The extent of this “subtle adjustment” may vary based on context. For continuously distributed data like income or age, such adjustments might be incremental. On the other hand, for categorical data such as gender or vehicle type the change is often discrete.

The terms “explainable AI” (XAI), “interpretable AI,” and “responsible AI” may be used interchangeably herein to refer to advanced computational frameworks, methods, and technologies in the realm of AI/ML designed to clarify the reasoning processes of intricate models, including but not limited to Local Interpretable Model-agnostic Explanations (LIME), SHapley Additive explanations (SHAP), and Partial Dependence Plots (PDP). The term “XAI” does not encompass CEs (counterfactuals). XAI aims to reconcile the intricate functionalities of AI systems with human-centric needs for accountability and comprehensibility by providing unambiguous justifications for decisions made by computing devices. In recent years, there has been an increased focus on “explainability” and “interpretability” in XAI stems.

The term “explainability” may be used herein to refer to a value or information structure that may be used to quantify the extent to which a human is capable of grasping the sequence of events that guide a AI/ML model or AI system to a particular outcome.

The term “interpretability” may be used herein to refer to a value or information structure that may be used to quantify how straightforward it is for a person to make sense of a result regardless of whether or not the internal mechanics of the model are known.

The term “automated decision system” (ADS) may be used herein to refer to a computational framework that uses AI/ML to make decisions or predictions without direct human intervention. An ADS may analyze vast amounts of data, identify patterns, and apply predefined rules or learned behaviors to arrive at conclusions or actions.

The term “combinatorial optimization” may be used herein to refer to a technique or technology for finding the best possible solution from a finite set of possible solutions, given certain constraints. Combinatorial optimization solutions may focus on identifying the most efficient, least costly, or most beneficial arrangement or combination of elements within a system. Classic examples include the traveling salesman problem in which the objective is to determine the shortest possible route that visits each city once and returns to the origin city, and the knapsack problem in which one may select items with given weights and values to maximize the total value without exceeding a weight limit. As these problems grow in size or complexity, their solution space may expand exponentially, making them computationally challenging.

The term “ad campaign optimization” may be used herein to refer to a digital advertising problem that includes a number of complexities, especially when it comes to efficiently utilizing budgets to reach the intended audience. Demographic filters play a pivotal role in shaping database queries that target this audience. Challenges emerge when there are discrepancies between campaign costs and allocated budgets or when strategic shifts occur mid-campaign. Such shifts might be instigated by fresh insights or changes in campaign goals. The various embodiments provide a structured methodology to overcome these and other technical challenges. For example, some embodiments may use AI/ML models trained on campaign parameters. As a result, the system may iteratively recalibrate the parameters to allow the campaigns to be executed efficiently, adhere to budgetary confines, and accommodate strategic pivots.

The terms “data warehouse,” “data lake” and the like may be used herein to refer to centralized storage systems for large volumes of data. A data warehouse and a data lake may serve different purposes and/or may have distinct architectures. A data warehouse may be a structured repository specifically designed for data analysis and reporting. A data warehouse may integrate data from multiple sources and organize it into a consistent, processed format, typically using a star or snowflake schema. This structured format allows for efficient querying and supports business intelligence tools and activities. A data lake may be a more flexible storage system used to store vast amounts of raw data in its native format, be it structured, semi-structured, or unstructured. This may include everything from relational data to log files and even multimedia content. An important advantage of a data lake may be its adaptability, as it may allow businesses to store data without initial preprocessing and offers the capability to process and analyze diverse datasets in a more agile manner. On the other hand, the broad and raw nature of a data lake may also pose challenges to data governance and data quality.

The term “data clean room” (DCR) may be used herein to refer to a model that represents an advanced data-sharing methodology crafted to align with contemporary privacy regulations. By creating a secure environment for data sharing, a DCR may help ensure compliance with rigorous privacy standards, such as GDPR and CCPA. Yet, using conventional solutions, it may be technically challenging to address the inadvertent initiation of sensitive queries without hindering the functional integrity of the system. The various embodiments provide an iterative evaluation and refinement of query sensitivity, ensuring both data protection and operational efficiency.

The term “sensitivity constraint” may be used herein to refer to a predefined criterion that requires a minimum number of records to be retrieved by a database query. The sensitivity constraint may be used to verify the comprehensiveness and the quality of the data retrieved from the database. If a query fails to meet this minimum threshold, it may be considered “sensitive,” implying that the data returned may not be sufficiently robust for reliable analysis or may not adhere to specific data privacy guidelines.

The term “sensitivity_threshold” may be used herein to refer to the minimum acceptable count of records that a query should return in order to consider the query results as adequately sensitive. This threshold may serve to operate as a constraint during query optimization and relaxation.

The term “feature” may be used herein to refer to a specific attribute or dimension within a dataset that is being considered for analysis or query operations. A feature may be a column in a relational database or a key-value pair in a NoSQL store. A feature may represent a specific aspect of the data, such as age, income, or geographic location.

The term “feature_space” may be used herein to refer to the multi-dimensional representation of all features being considered in a dataset. A feature_space may serve to operate as the domain in which queries are made. A feature_space may include various features that contribute to the robustness of the dataset.

The term “original_query” may be used herein to refer to the initial set of conditions or intervals specified by a user or system for retrieving data from the feature_space. The original_query may be the baseline query before any modifications or relaxations are performed.

The term “ΔXi values” may be used herein to refer to the adjustments or modifications made to the intervals or conditions of a particular feature ‘i’ during the query relaxation and optimization operations. These adjustments aim to change the query in a way that meets the sensitivity_threshold while reducing or minimizing loss.

The term “Query Relaxation” may be used herein to refer to the process of iteratively adjusting or expanding the intervals or conditions of the original query in an attempt to satisfy a predetermined sensitivity_threshold. The Query Relaxation process may include modifying feature conditions and optimizing the loss function.

The term “Lagrange Multiplier” may be used herein to refer to a computational technique often used in constrained optimization problems to find the maximum or minimum of a function subject to equality constraints.

The term “Knapsack Analogy” may be used herein to refer to a problem-solving approach likened to the Knapsack Problem in computer science. It involves optimizing a set of items under a capacity constraint and is often used to improve or optimize feature conditions in the query relaxation process.

The term “Gradient Descent” may be used herein to refer to an iterative optimization algorithm for finding the minimum of a function. In the context of query relaxation and optimization, it may be used to find the set of ΔXi values that minimizes the loss function.

The term “solution set” may be used herein to refer to a collection of all potential sets of ΔXi adjustments that could be made to an original query. Some embodiments may be configured to determine the solution set to meet or exceed the sensitivity_threshold and may be optimized based on a loss function.

Various embodiments include computing devices equipped with processors and components configured to enhance queries in multi-dimensional feature spaces and/or manipulate multi-dimensional feature spaces in databases to satisfy specific query criteria while minimizing deviations from original queries.

There are a number of technical challenges associated with generating optimized queries in a multi-dimensional feature space within databases. For example, each column in a database may represent a specific feature (e.g., age group, income bracket, etc.), which may be conceptualized within a “feature space.” In certain instances, initial queries in this feature space might return results that do not meet predefined sensitivity thresholds. The embodiments may include components configured to overcome these and other limitations of conventional solutions by manipulating the feature space to satisfy the sensitivity thresholds while reducing or minimizing deviation from the original query.

In some embodiments, the components may be configured to use a loss function to minimize deviations from the original query. The loss function may reduce or minimize the widths of the extended feature intervals (ΔXi), subject to meeting the predefined sensitivity threshold (e.g., a minimum of 10 records, etc.). In some embodiments, the components may be configured to adjust the loss function based on the relative importance of different features (denoted as weights (wᵢ) or “feature weights”), which may be statically stored in the computing device or dynamically supplied based on the query context. In some embodiments, the components may be configured to dynamically adjust or make real-time updates to the weights (wᵢ) based on the context of the original query.

In some embodiments, the components may be configured to perform the loss function as part of a more robust query optimization process and/or as part of a “query relaxation and optimization loop.” As a detailed example, the components may initialize various variables and data structures, including a feature space (“feature_space”) for representing the multi-dimensional database, an original query (“original_query”) for storing the initial query intervals, a sensitivity threshold (“sensitivity_threshold”) for setting a minimum acceptable record count, weights (“wᵢ”) for storing the importance of each feature, and a solution set (“solution_set”) for storing potential sets of ΔXi. The processor may use the original_query to perform an initial query on feature_space, count the number of records retrieved by the initial query, store the count of records retrieved in record_count, and determine whether the record_count meets or exceeds the sensitivity_threshold. If so, the processor may return the query results and terminate the process.

In some embodiments, in response to determining that the record_count does not meet or exceed the sensitivity_threshold, the processor may optionally initialize a loss_function based on any or all of the following equations:

$$L = {Σ}_{i} {w}_{i} Δ {X}_{i}$$

$$L = Π [ {( {X}_{i} + Δ {X}_{i} )}^{n} - {X}_{i}^{n} ] or$$

$$L = Π [ {( {X}_{i} + {w}_{i} Δ {X}_{i} )}^{n} - {X}_{i}^{n} ]$$

In addition, in response to determining that the record_count does not meet or exceed the sensitivity_threshold, the processor may enter a “query relaxation and optimization loop” in which the processor iteratively traverses each feature “i” in feature_space, determines possible ΔXi values within a permissible range for each feature, determines a new_loss value based on the loss_function value for each of the determined ΔXi values, determines whether the new_loss value is reduced or minimized (e.g., a minimized loss function), determines whether record_count satisfies or exceeds the sensitivity_threshold, and updates the solution_set and the record_count in response to determining that the new_loss is minimized and record_count satisfies sensitivity_threshold.

In some embodiments, the components may be configured to update the weights (wᵢ) to adjust feature importance and subsequently re-run the query relaxation and optimization loop and/or to adjust the loss_function value to favor compact queries and re-run the query relaxation and optimization loop. In some embodiments, the components may be configured to select an optimization method (e.g., LaGrange multiplier, knapsack, gradient descent, etc.), apply the selected optimization method to determine an optimal solution_set, use the adjusted loss_function to evaluate the final solution_set, and return a modified query or a dataset that satisfies the sensitivity_threshold with the minimum loss value.

In some embodiments, the components may be configured to use a relational database management system (RDBMS) that uses structured query language (SQL) for querying data. In some embodiments, the components may be configured to extend their functionalities beyond traditional RDBMS that use SQL for querying data. These extended functionalities may be applied to any of a variety of different types of databases or data stores, including non-relational databases such as NoSQL databases (e.g., MongoDB, etc.), graph databases, vector databases, etc.

In some embodiments, the components may be configured to improve or optimize queries to a graph database. Graph databases may include distinct storage and querying mechanisms that make them particularly well-suited for representing complex networks. In these databases, entities may be denoted as nodes and the relationships between them may be denoted as edges. In some embodiments, the components may be configured to apply the above-described techniques to a graph database to discover specific paths or relationships between nodes while complying with the sensitivity thresholds.

In some embodiments, the components may be configured to improve or optimize queries to a vector database. Vector databases may use vector embeddings for data storage and/or otherwise support advanced semantic search capabilities. In some embodiments, the components may be configured to apply the above-described techniques to a vector database to identify the most semantically similar vectors in a given query.

In some embodiments, the components may be configured to improve the quality and efficacy of large language model (LLM) prompts. In some embodiments, the components may be configured to adjust the query parameters to meet predefined sensitivity thresholds while improving or maintaining the quality of the LLM-generated results. In some embodiments, the components may be configured to apply or use mathematical operations with geometric interpretations to vector embeddings to generate better, more accurate, more relevant, and/or more nuanced LLM query results.

In some embodiments, the components may be configured to reduce, mitigate, or overcome well-known limitations in LLMs, such as hallucinations (plausible yet inaccurate responses). In some embodiments, the components may be configured to intelligently adjust the temperature setting of the LLM model, which is a parameter that impacts the level of randomness in the output and influences the propensity for hallucinations in LLM systems.

In some embodiments, the components may be configured to use reinforcement learning from human feedback (RLHF). While human oversight may improve model validation, conventional RLHF solutions include significant manual operations that could significantly limit scalability. In some embodiments, the components may be configured to use counterfactuals to improve model performance and reduce RLHF manual procedures.

In some embodiments, the components may be configured to balance tradeoffs between the “creativity” of the model's output with its factual accuracy. For example, in some embodiments, the components may be configured to adjust the “temperature” setting of the LLM. Generally, the level of creativity may increase as vector endpoints accumulate more data. To address this issue, the components may be configured to use counterfactuals and temperature adjustments to calibrate or fine-tune tradeoffs between creativity and accuracy.

In some embodiments, the components may be configured to overcome various technical challenges associated with conventional counterfactuals and automated decision systems (ADS) and mitigate known barriers such as the Rashomon Effect (e.g., having too many alternate solutions that are equally plausible). For example, conventional counterfactual systems often focus on “sparsity,” meaning they try to change as few features as possible to arrive at a different decision. In some embodiments, the components may be configured to relax “sparsity” and/or other traditional constraints commonly associated with counterfactuals. In some embodiments, the components may be configured to dynamically adapt to the varying importance of different features in the decision-making process and generate more efficient and compact queries. In some embodiments, the components may be configured to incorporate and use mathematical constraints (e.g., L=Σᵢ wᵢ ΔXᵢ; L=Π[(Xᵢ+ΔXᵢ)ⁿ−Xᵢⁿ] or; L=Π[(Xᵢ+wᵢ ΔXᵢ)ⁿ−Xᵢⁿ]) to evaluate and limit the magnitude of changes to individual features in the decision-making process. In some embodiments, the components may be configured to de-emphasize the conventional focus on sparsity in counterfactuals to improve the performance and functioning of an ADS. In some embodiments, the components may be configured to identify minimum perturbations in input features that yield a different output prediction to allow for changes to any number of features, provided each change is minimal. In some embodiments, the components may be configured to balance tradeoffs between explainability and effectiveness while addressing various challenges in database-driven ADSs.

In some embodiments, the components may be configured to use a combination of counterfactuals and XAI to evaluate AI/ML models. While XAI is robust in identifying the most influential features affecting a particular prediction, a conventional XAI system may include limitations in terms of computational intensity for exact solutions. On the other hand, counterfactuals may excel at generating alternate data points but may produce an overwhelming number of potential paths, making it challenging to identify the most relevant or useful scenarios.

In some embodiments, the components may be configured to generate initial AI/ML model predictions, apply approximate XAI methods (e.g., LIME, Kernel SHAP, PDP, etc.) to quickly identify the influential features for an initial prediction, apply the identified influential features as inputs to counterfactuals to generate a rule-constrained set of alternate scenarios and evaluate the results to select among the counterfactuals or generated alternate scenarios. As such, the components may be configured to weave together the strengths and mitigate the weaknesses of both XAI and CE. This hybrid approach may provide a comprehensive and efficient solution that is especially well-suited for the nuanced requirements of automated decision systems.

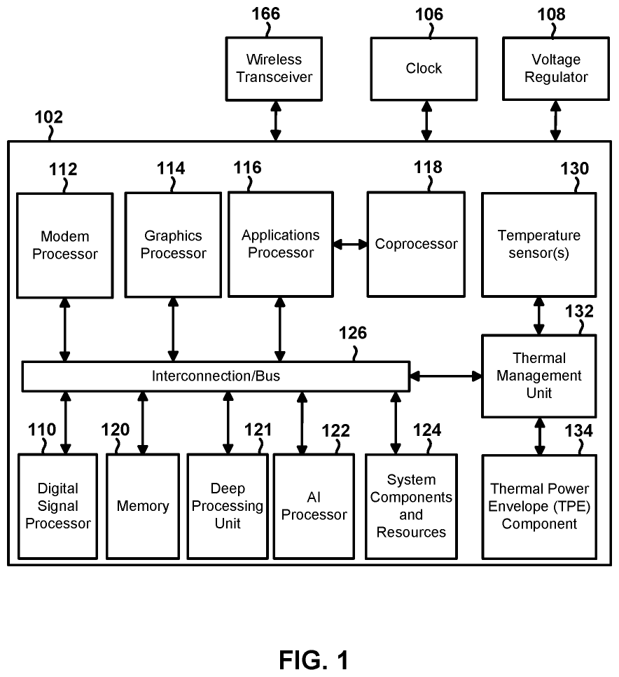

Various embodiments may be implemented on a number of single-processor and multiprocessor computer systems, including a system-on-chip (SOC) or system in a package (SIP). FIG. 1 illustrates an example computing system 100 architecture that may be used in a computing system implementing the various embodiments.

The example SOC 100 illustrated in FIG. 1 includes SOC 102, a clock 106, a voltage regulator 108, and wireless transceiver 166. The SOC 102 may communicate via interconnection/bus module 150. The various processors 110, 112, 114, 116, 118, 121, 122, may be interconnected to each other and to one or more memory elements 120, system components and resources 124 and a thermal management unit 132 via an interconnection/bus module 126. The interconnection/bus module 126 may include an array of reconfigurable logic gates and/or implement a bus architecture (e.g., CoreConnect, AMBA, etc.). Communications may be provided by advanced interconnects, such as high-performance networks-on-chip (NoCs).

In some embodiments, the SOC 102 may operate as the central processing unit (CPU) of the mobile computing device that carries out the instructions of software application programs by performing the arithmetic, logical, control and input/output (I/O) operations specified by the instructions. In some embodiments, the modem processor 112 may operate as a specialized 5G processing unit responsible for managing high volume, high speed (e.g., 5 Gbps, etc.), and/or very high-frequency short wavelength (e.g., 28 GHz mm Wave spectrum, etc.) communications.

The SOC 102 may include a digital signal processor (DSP) 110, a modem processor 112, a graphics processor 114, an application processor 116, one or more coprocessors 118 (e.g., vector co-processor) connected to one or more of the processors, memory 120, deep processing unit (DPU) 121, artificial intelligence processor 122, system components and resources 124, an interconnection/bus module 126, one or more temperature sensors 130, a thermal management unit 132, and a thermal power envelope (TPE) component 134.

Each processor 110, 112, 114, 116, 118, 121, 122, 121, 122 may include one or more cores, and each processor/core may perform operations independent of the other processors/cores. For example, the first SOC 102 may include a processor that executes a first type of operating system (e.g., FreeBSD, LINUX, OS X, etc.) and a processor that executes a second type of operating system (e.g., MICROSOFT WINDOWS 10). In addition, any or all of the processors 110, 112, 114, 116, 118, 121, 122 may be included as part of a processor cluster architecture (e.g., a synchronous processor cluster architecture, an asynchronous or heterogeneous processor cluster architecture, etc.).

Any or all of the processors 110, 112, 114, 116, 118, 121, 122 may operate as the CPU of the mobile computing device. In addition, any or all of the processors 110, 112, 114, 116, 118, 121, 122 may be included as one or more nodes in one or more CPU clusters. A CPU cluster may be a group of interconnected nodes (e.g., processing cores, processors, SOCs, SOCs, computing devices, etc.) configured to work in a coordinated manner to perform a computing task. Each node may run its own operating system and contain its own CPU, memory, and storage. A task that is assigned to the CPU cluster may be divided into smaller tasks that are distributed across the individual nodes for processing. The nodes may work together to complete the task, with each node handling a portion of the computation. The results of each node's computation may be combined to produce a final result. CPU clusters are especially useful for tasks that can be parallelized and executed simultaneously. This allows CPU clusters to complete tasks much faster than a single, high-performance computer. Additionally, because CPU clusters are made up of multiple nodes, they are often more reliable and less prone to failure than a single high-performance component.

The SOC 102 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 124 of the first SOC 102 may include power amplifiers, voltage regulators, oscillators, phase-locked loops, peripheral bridges, data controllers, memory controllers, system controllers, Access ports, timers, and other similar components used to support the processors and software clients running on a mobile computing device. The system components and resources 124 may also include circuitry to interface with peripheral devices, such as cameras, electronic displays, wireless communication devices, external memory chips, etc.

The SOC 102 may further include an input/output module (not illustrated) for communicating with resources external to the SOC, such as a clock 106, a voltage regulator 108, and a wireless transceiver 166 (e.g., cellular wireless transceiver, Bluetooth transceiver, etc.). Resources external to the SOC (e.g., clock 106, voltage regulator 108, wireless transceiver 166) may be shared by two or more of the internal SOC processors/cores.

In addition to the example SOC 100 discussed above, various embodiments may be implemented in a wide variety of computing systems, which may include a single processor, multiple processors, multicore processors, or any combination thereof.

In addition to the example SOC 100 discussed above, various embodiments may be implemented in various computing systems, including a single processor, multiple processors, multicore processors, or any combination thereof.

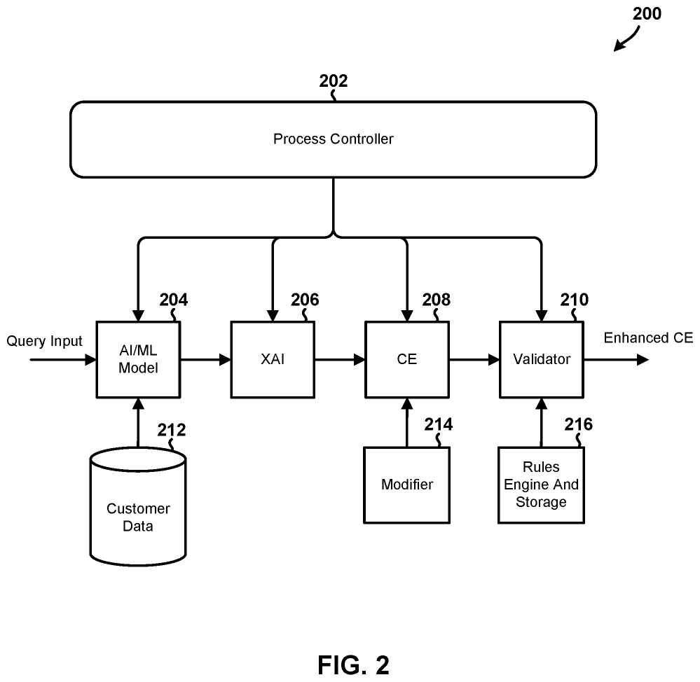

FIG. 2 illustrates example components that could be included in an automated decision system (ADS) 200 that is configured to operate on any of all of the processors or processing systems (e.g., SOC 100, processors 110, 112, 114, 116, 118, 121, 122, etc.) to implement the various embodiments. In the example illustrated in FIG. 2, the ADS 200 includes a process controller 202 component, a machine learning (ML) model 204 component, an XAI 206 component, a CE 208 component, a validator 210 component, a customer data 212 component, a modifier 214 component, and a rules engine and storage 216 component. In some embodiments, the ADS 200 may also include a training component (not illustrated separately in FIG. 2) that is configured to train the AI/ML models so as to ensure that the AI/ML model 204 component identifies counterfactuals.

The ADS 200 may be configured to receive a query as input and generate an enhanced counterfactual explanation (enhanced CE) as an output.

The process controller 202 may be configured to facilitate connectivity to all other components (204-216), such as through REST APIs. The process controller 202 may also be configured to manage automated processes and perform iterative calculations (e.g., based on settings defined in the rules engine and storage 216 component, etc.).

The AI/ML model 204 component may include logic and information structures that may be used by a device processor to evaluate collected data or a specific feature (or factor, condition, data point, operation, component, etc.). For example, the AI/ML model 204 component may include a classifier that includes include decision nodes (e.g., neural networks, decision stumps, boosted decision trees, etc.) that each include a weight value and a test question/condition suitable for evaluating the collected data.

The XAI 206 component may be an advanced computational framework that includes multiple layers of neural networks with millions or billions of parameters and/or any of a variety of specialized AI models (e.g., LLMs, etc.). Unlike traditional systems that translate user prompts into a series of correlated files or web pages for navigation, an LLM may support dialogic interactions and encapsulate expansive knowledge in an internal structure. As a result, rather than merely serving a list of relevant websites, LLMs are capable of providing direct answers and/or are otherwise adept at various tasks, such as text summarization, translation, complex question-answering, conversational agents, etc. In various embodiments, the XAI 206 component may operate independently as standalone units, may be integrated into more comprehensive systems and/or into other computational units (e.g., SOC 100, processors 110, 112, 114, 116, 118, 121, 122, etc.).

The CE 208 component may be configured to generate CEs or counterfactuals, which may information units (e.g., string vector information structure, etc.) that include alternative outcomes by proposing minor adjustments to input attributes. The CE 208 component may work in conjunction with the AI/ML model 204 to provide insights into how specific input modifications could lead to different outcomes. CEs may allow for a “what-if” analysis that contributes to a deeper understanding of the decisions made by the ADS 200 and/or improves the system's transparency. The CE 208 component may identify incremental adjustments that could result in different model predictions for continuous data types (e.g., income, age, etc.). The CE 208 component may identify changes to categorical data types (e.g., gender, vehicle type, etc.) in discrete or distinct non-continuous increments. The CE 208 component may work in conjunction with the process controller 202 for connectivity, the validator 210 for initial validation of queries, and the rules engine and storage 216 for adhering to preset parameters or rules. The CE 208 component may also work in conjunction with the modifier 214 component to generate counterfactual explanations that deviate from traditional sparsity constraints and/or to adjust for varying feature importance.

The validator 210 component may be configured to perform initial query validations, such as machine-learning-based feature importance analysis. The validator 210 component may also perform validation analysis on the filtered counterfactuals (which may be subjected to iterative modifications if the solutions do not converge).

The modifier 214 may be configured to provide modified or tailored counterfactual explanation (CE) algorithms that are not bound by traditional sparsity constraints and/or may adjust for variations in feature importance.

The rules engine and storage 216 component may be configured to store user-defined preferences and rules, maintain query parameters and contexts from previous AI/ML analyses, and weigh parameters to account for feature importance.

In some embodiments, the components may be configured to generate data points for counterfactuals directly from the main database, bypassing the need for training AI/ML models on external data. In some embodiments, the components may be configured to define input query parameters and auxiliary data, perform a preliminary validation of the input query parameters (e.g., via the validator component, etc.), execute the validated query on a pre-trained AI/ML model, use XAI analysis to identify influential features within the data, categorize the influential features based on their importance, divide the categorized features into subsets, apply a counterfactual algorithm that does not adhere to traditional sparsity constraints (thereby generating alternative scenarios or counterfactuals), prioritize the generated counterfactuals based on predefined rules or constraints, and select and apply the most actionable or useful counterfactuals (or highest priority counterfactuals, etc.). In some embodiments, the components may be configured to perform a convergence check to determine whether the process has stabilized. The components may revert to applying the modified counterfactual algorithm in response to determining that the process has not yet stabilized. The components may finalize the selected set of counterfactuals in response to determining that the process has stabilized (i.e., upon achieving convergence), and output the final set of enhanced CEs.

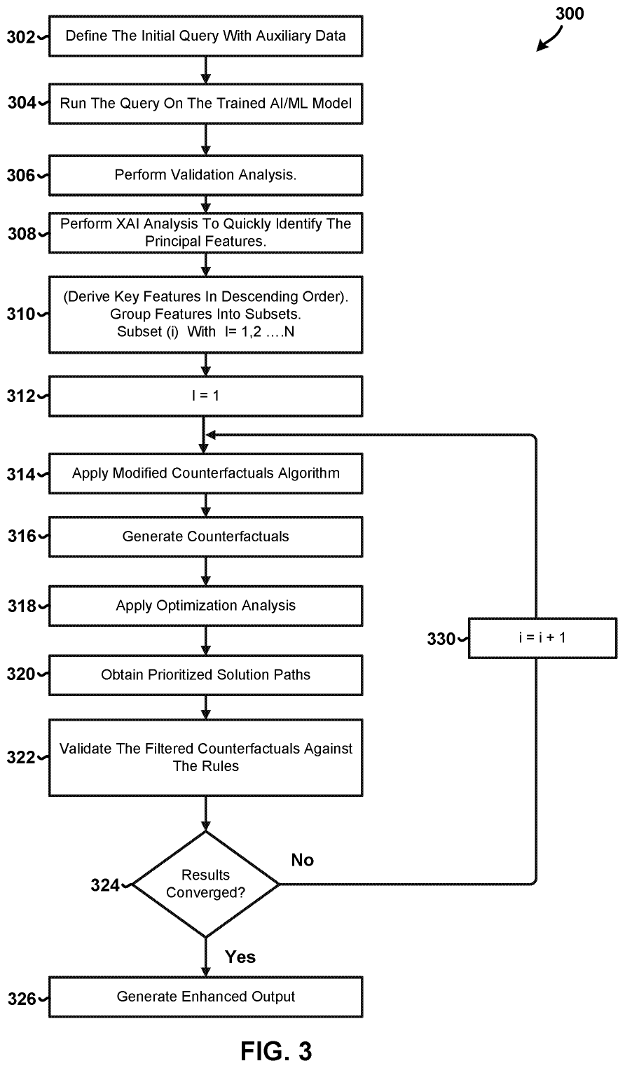

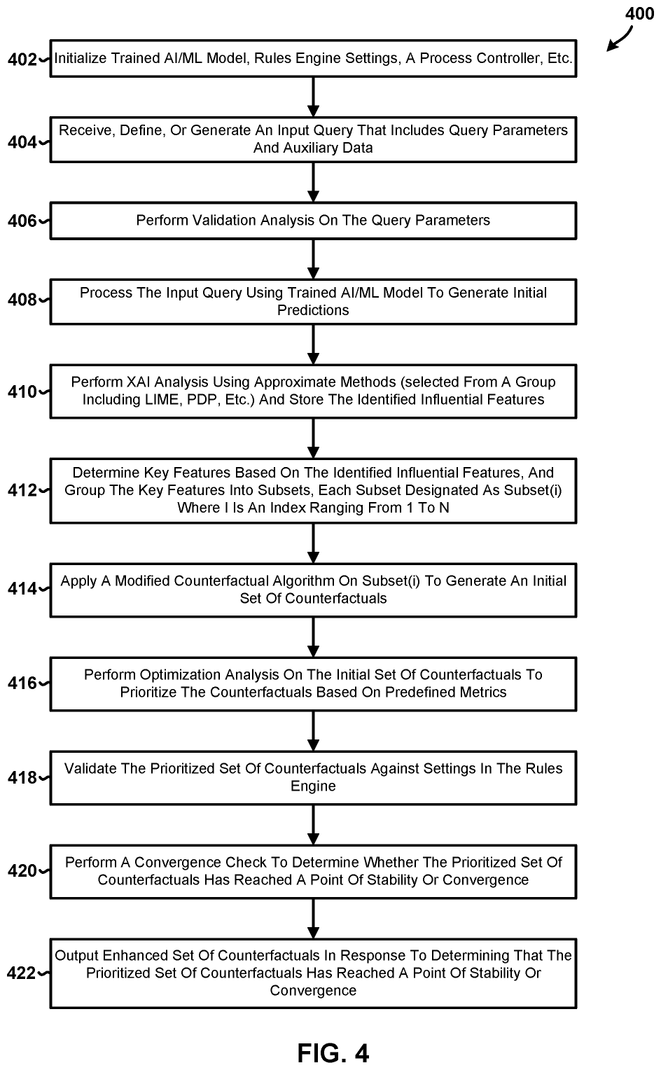

FIGS. 3 and 4 are process flow diagrams illustrating methods 300, 400 of generating enhanced counterfactuals (e.g., for improved queries, combinatorial optimization, ad campaign optimization, data clean room, etc.) in accordance with some embodiments. Method 300 may be executed on a computing device featuring one or more processors (e.g., SOC 100, processors 110, 112, 114, 116, 118, 121, 122, etc.). These processors, along with other hardware, software, firmware, etc., may form a processing system capable of carrying out the operations detailed in methods 300, 400. In some embodiments, the processing system may be included as part of ADS configured to autonomously analyze data, identify patterns, and apply predefined rules or learned behaviors to reach conclusions or take actions without human intervention.

With reference to FIG. 3, in block 302, the processing system may define or generate an initial query with auxiliary data. This initial query may include specific criteria under examination along with auxiliary data that adds nuanced context to the query. Auxiliary data may include temporal elements (e.g., timestamps, etc.) spatial elements (e.g., geolocation, etc.) or informational elements (e.g., metadata, etc.), each contributing to a more comprehensive query formulation. For examples involving data privacy considerations, the initial query may be an SQL query incorporating conditions related to aspects such as geolocation, device type, or browser history. Alternatively, in scenarios such as ad campaign optimization, the initial query may be generated based on a variety of criteria, including but not limited to, age group, income bracket, and geographic focus.

In block 304, the processing system may run the query on the trained AI/ML model. As discussed above, the AI model may include algorithms and methods to handle complex, multi-dimensional data. In some embodiments, the processing system may run the query on a trained AI/ML model that has been taught to understand the sensitivities around customer data under GDPR and CCPA regulations, trained to predict advertising campaign costs, etc.

In block 306, the processing system may perform validation analysis. The validation analysis operations may help ensure that both the initial query and its subsequent results follow predefined validation rules and guidelines. These rules/guidelines may encompass a range of considerations, including data type verification, boundary condition assessments, and tests for statistical robustness. For example, in scenarios related to Data Clean Room applications, the system could validate that an SQL query adheres to privacy regulations by passing it through a designated rule engine. Alternatively, in the context of ad campaign optimization, the system might verify that the estimated cost, as deduced from the query, adheres to pre-specified financial constraints, such as a budget limit of $10,000.”

In block 308, the processing system may perform XAI analysis to quickly identify the principal features, or the most influential features affecting the query results. In some embodiments, the processing system may use techniques such as LIME or Kernel SHAP to determine the features in the dataset that most substantially affect the outcomes. In some embodiments, the processing system may perform (e.g., for Data Clean Room applications) the XAI analysis to identify which query parts contribute to its sensitivity level. In some embodiments, the processing system may perform (e.g., for ad campaign optimizations, etc.) the XAI analysis to identify the input variables responsible for pushing the estimated cost beyond the allocated budget.

In some embodiments, the processing system may identify the principal features by initially preparing the dataset and the query, storing the original output of the AI model for subsequent comparisons, systematically perturbating the individual features in the dataset to re-evaluate the AI model and observe the impact of each feature on the output, and using techniques such as LIME or Kernel SHAP to calculate the importance score for each feature and/or otherwise determine the features in the dataset that most substantially affect the outcomes. In the above DCR example, these operations may allow the processing system to determine specific conditions that make a query especially sensitive and/or which could lead to privacy violations. Once the principal features responsible for this sensitivity are identified, they may be altered or relaxed to ensure the query's compliance with privacy regulations. Similarly, in ad campaign optimization example in which budget constraints are a concern, the processing system may use the XAI analysis to determine which features (e.g., age group, income bracket, etc.) are predominantly driving the costs higher than the budget.

In block 310, the processing system may derive key features in descending order and group the features into subsets (e.g., subset (i) with i=1,2 . . . . N). For example, the processing system may organize the identified features based on their calculated influence. These ordered features may be grouped into subsets (e.g., subset (i) with i=1, 2, . . . . N) that allow for more targeted analysis. For example, in some embodiments, the processing system may rank the identified sensitive query components and segregate them into manageable subsets based on their impact on customer data privacy. In some embodiments, the processing system may group the influential features by their impact on cost and create subsets for analysis.

In block 312, the processing system may initialize the index variable (e.g., set I=1). In blocks 314 and 316, the processing system may apply a modified counterfactual algorithm to generate counterfactuals (e.g., to understand how varying the input parameters could lead to different outcomes, etc.). The modified counterfactual algorithm may generate alternative data points while adhering to certain constraints or rules. In some embodiments, the modified counterfactual algorithm may be configured to find the nearest data point that would alter the outcome while complying with predefined conditions.

In some embodiments, the processing system may apply a modified counterfactual algorithm to explore alternative less-sensitive queries and generate a list of alternative SQL queries that are compliant with GDPR and CCPA. For example, in a DCR application in which query sensitivity is a concern, the modified counterfactual algorithm could generate counterfactuals that demonstrate how slight changes in the query conditions could lead to results that are compliant with privacy regulations. The processor may take an overly sensitive query and generate counterfactuals that show alternative queries that are much less likely to violate privacy norms.

In some embodiments, the processing system may apply a modified counterfactual algorithm to generate alternative feature sets that would meet the budget and generate counterfactuals with different combinations of age group, income bracket, etc., and assess their impact on cost. For example, in an ad campaign optimization application in which budget is a concern, if the initial query predicts an over-budget cost of $11,600 on a $10,000 budget, the processing system may apply the modified counterfactual algorithm to find the closest parameter values (e.g., slightly broader age group, different income bracket, or even different geographic targeting) that would bring the campaign cost below the $10,000 threshold. These counterfactuals may serve as immediate actionable insights for optimizing the campaign without a significant overhaul.

In block 318, the processing system may apply optimization analysis. In some embodiments, the optimization analysis may include using mathematical models or algorithms to evaluate the efficiency and effectiveness of each alternative based on predefined metrics or objectives. Continuing the DCR example above, the optimization analysis may include evaluating counterfactual queries based on multiple metrics (e.g., query sensitivity, data coverage, computational cost, etc.) and identifying a set of query alternatives that minimize sensitivity and computational cost while maximizing data coverage (or result accuracy, execution efficiency, data output quality, etc.).

In block 320, the processing system may obtain prioritized solution paths based on the optimization analysis. For example, the processing system may assign scores or ranks to the generated counterfactuals in block 320. In some embodiments, the processing system may prioritize the optimized queries based on a set of criteria such as speed and compliance score. In some embodiments, the processing system may prioritize the optimized counterfactuals based on the projected performance and budget constraints.

In block 322, the processing system may validate the filtered counterfactuals (e.g., the high-priority counterfactuals) against a set of predefined rules or constraints to help ensure that each counterfactual is both plausible and useful in the given context. For example, the processing system may validate the optimized less-sensitive queries to ensure they comply with the data clean room policies. As another example, the processing system may validate the counterfactuals to ensure they align with any mid-campaign strategic changes.

In determination block 324, the processing system may determine whether the results converged to a stable solution. In some embodiments, the processing system may determine whether the result converge by determining whether the results have attained a certain accuracy level or whether multiple iterations through the loop have generated the same or similar results with few changes. In some embodiments, the processing system may determine whether the optimized queries satisfy all the pre-set conditions and/or check for convergence in the optimized counterfactuals.

In response to determining that the results converge (i.e., determination block 324=“Yes”), the processing system may generate enhanced output in block 326 based on the validated and prioritized counterfactuals. For example, the processing system may output an optimized query for data clean room or output an optimized feature set for advertising campaigns.

In response to determining that the results do not converge (i.e., determination block 324=“No”), the processing system may increment the index variable (e.g., I=I+1) and repeat the operations in blocks 314-330 until the results converge (e.g., multiple iterations through the loop have generate the same or similar results, etc.).

With reference to FIG. 4, in block 402, the processing system may initialize a trained AI/ML model, rules engine settings, a process controller, etc.

In block 404, the processing system may receive, define, or generate an input query that includes query parameters and auxiliary data. The input query may serve as the basis for downstream analysis and decision-making. For example, the query parameters may include a user's age, income, and geographical location, while the auxiliary data could be metadata such as the time the query was generated. The system may store these as key-value pairs in a dictionary for easy retrieval. Said another way, the processing system may receive an input query that includes query parameters and auxiliary data in block 404.

In block 406, the processing system may perform validation analysis on the query parameters. The validation analysis operations may help ensure that the received data conforms to expected standards and avoids erroneous results later in the pipeline. For example, age should be a positive integer, and geographical location could be verified against a list of legitimate locations.

In block 408, the processing system may process the input query by using the trained AI/ML model to generate initial predictions. Said another way, the processing system may apply the received input query to an AI model to generate an initial prediction in block 408. The AI/ML model may apply learned patterns to new data to produce an outcome (predictions). For example, given the age, income, and location data from the input query, the AI/ML model might predict the likelihood of the user buying a particular product.

In some embodiments, the AI model may be a neural network that includes interconnected processing nodes that collectively control a function of a computing device and generate neural network inferences. In some embodiments, the neural network may include multiple layers and the computations may be distributed over a population of processing nodes in a layered architecture. In some embodiments, each layer in the neural network may have multiple inputs, allowing for the processing of multiple preceding layers. In some embodiments, inference may be performed at runtime during the execution of the software application program corresponding to the neural network as data traverses the processing nodes along a forward path to produce an overall activation or inference result.

In some embodiments, the AI model may be CNN and/or include at least one neural network layer that implements a convolution-based structure. In some embodiments, the AI model may be a GNN configured to process graph-structured data representing relationships and interactions among entities. In some embodiments, the AI model may be a classifier, evaluating collected data or specific features and featuring decision nodes with weight values and test conditions.

In block 410, the processing system may perform XAI analysis using approximate methods (selected from a group including LIME, Kernel SHAP, PDP, etc.) to identify influential features and store the identified influential features in memory. The XAI analysis operations may help determine the features that have a considerable influence on the prediction. For example, using Kernel SHAP, the system may find that age and location are the most influential features in the prediction. These identified fields may then be stored (e.g., as elements in an array or list, etc.) for further analysis.

In various embodiments, the XAI analysis may include the application of techniques such as LIME, SHAP, and PDP to clarify the reasoning processes of AI models. In some embodiments, performing the XAI analysis may include providing unambiguous justifications for decisions made by computing devices and/or quantify the extent to which a human may grasp the sequence of events that guide the AI model to a particular outcome. In some embodiments, performing XAI analysis may include generating interpretability values that quantify how straightforward it is for a person to make sense of a result regardless of whether or not the internal mechanics of the AI model are known.

In some embodiments, performing XAI analysis using approximate methods to identify influential features in block 410 may include creating a new dataset by perturbing features of the generated initial predictions that need to be explained, using a trained AI/ML model to make predictions on the perturbed samples, assigning weights to the perturbed samples based on their similarity to the generated initial predictions, and applying a linear regression model to the perturbed samples using the assigned weights.

In block 412, the processing system may determine key features based on the identified influential features, and group the key features into subsets, each subset designated as Subset (i) where i is an index ranging from 1 to N. This arrangement may allow for a more focused and granular analysis in subsequent steps. For example, if age and location are determined to be key features, they may form Subset (1), while income could form Subset (2).

In block 414, the processing system may apply a modified counterfactual algorithm on Subset(i) to generate an initial set of counterfactuals. Said another way, the processing system may apply the determined key features to a modified counterfactual model to generate an initial set of counterfactuals in block 414. These operations allow for exploring alternative scenarios that would result in different outcomes. For example, using the modified counterfactual algorithm, the system may generate scenarios in which changing the age or location would have led to a different purchasing decision.

In various embodiments, applying the determined key features to a modified counterfactual model to generate the initial set of counterfactuals in block 414 may include applying the determined key features to a counterfactual model with relaxed sparsity to generate the initial set of counterfactuals, applying the determined key features to the modified counterfactual algorithm to identify alternative less-sensitive queries and generate a list of alternative queries that are compliant with CCPA or GDPR, and/or applying the determined key features to the modified counterfactual algorithm generate counterfactuals with different combinations of categorical data types. In some embodiments, the counterfactuals may suggest alternative results and/or slight alterations to input attributes, allowing a deeper understanding of model predictions. In some embodiments, the counterfactuals may pinpoint the subtlest adjustments in input attributes that would prompt distinct predictions from the AI/ML system. In some embodiments, the extent of adjustment may vary based on context.

In block 416, the processing system may perform optimization analysis on the initial set of counterfactuals to prioritize the counterfactuals based on predefined metrics. This may allow the system to identify the most relevant and actionable counterfactuals. For example, counterfactuals leading to substantially different outcomes might be ranked higher and/or included in a sorted list.

In block 418, the processing system may validate the prioritized set of counterfactuals against settings in the rules engine. Validating the prioritized set of counterfactuals may help ensure that the selected counterfactuals adhere to predefined rules or constraints. For example, if the rules engine has a setting that rules out any counterfactuals that involve illegal activities, those could be removed from the list in block 418.

In block 420, the processing system may perform a convergence check to determine whether the prioritized set of counterfactuals has reached a point of stability or convergence. Performing the conference check may allow the processing system to determine whether the iterative process has arrived at a consistent set of counterfactuals or if the changes between the prioritized lists in consecutive iterations are below a certain threshold.

In some embodiments, the processing system may use a delta comparison between iterations or calculate the difference between the prioritized sets of counterfactuals from two consecutive iterations. For example, if the prioritized set of counterfactuals is represented as an ordered list based on a scoring metric: [C1, C2, C3] in one iteration and [C1, C4, C3] in the subsequent iteration, the processing system could compare these lists elementwise and quantify the difference. In this example, the delta may be computed as the number of elements that differ between the two ordered lists, which in this case is just one element (C2 is replaced by C4). If the delta is below a predefined threshold, the system may consider that the prioritized set of counterfactuals has reached a point of stability.

As another example, the processing system may examine the scores assigned to each counterfactual to check for convergence. If the scores for corresponding counterfactuals between two successive iterations differ by less than a predefined value, the process could be considered to have converged. For example, if the scores for counterfactuals C1, C2, and C3 in one iteration are [0.9, 0.7, 0.6] and in the next iteration, the scores are [0.91, 0.69, 0.59], the differences are within a small margin (0.01). The set may be considered stable if this margin is below the predefined value (e.g., 0.02).

In block 422, the processing system may output enhanced set of counterfactuals in response to determining that the prioritized set of counterfactuals has reached a point of stability or convergence. Otherwise, the processing system may increment index i and return to block 414 in response to determining that the prioritized set of counterfactuals has not reached the point of stability or convergence.

In some embodiments, method 400 may further include using combinatorial optimization techniques to find the best possible solution from a finite set of possible solutions, given certain constraints, within the context of ad campaign optimization. In some embodiments, method 400 may further include using advanced data-sharing methods, such as data clean room (DCR), to ensure compliance with privacy regulations. In some embodiments, the data (e.g., auxiliary data, etc.) may be stored in a data warehouse or a data lake. Some embodiments may include enforcing sensitivity constraints, adjusting feature conditions through query relaxation, employing Lagrange Multipliers and a Knapsack Analogy, utilizing Gradient Descent for loss function optimization, and/or determining solution sets for query adjustments to meet or surpass sensitivity thresholds followed by optimization based on a loss function.

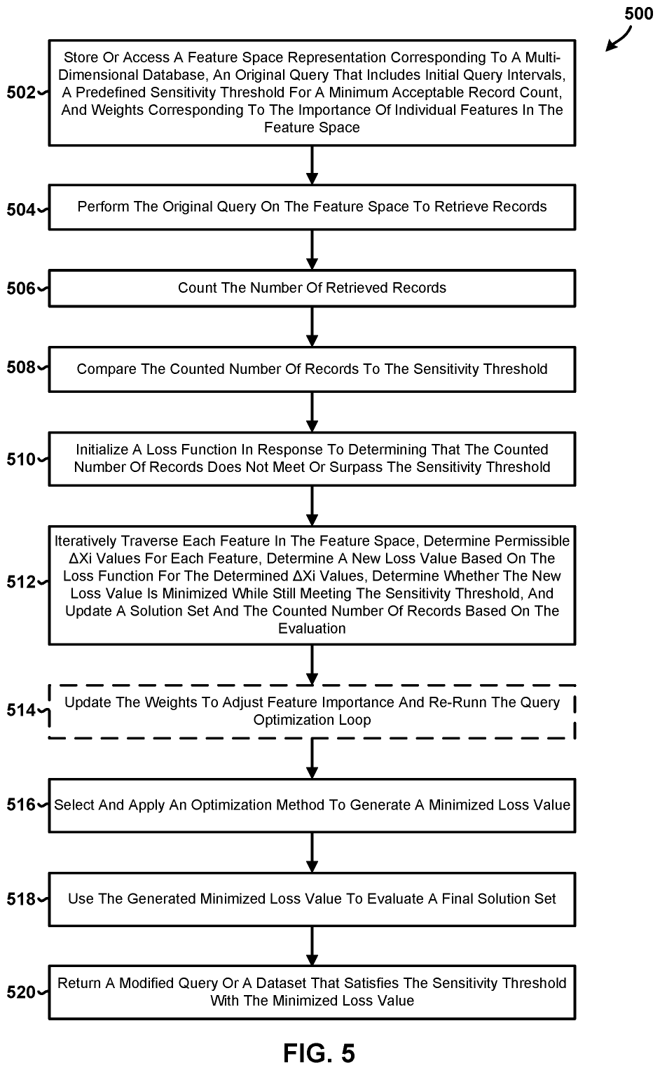

FIG. 5 is a process flow diagram illustrating a method 500 of enhancing database queries within multi-dimensional feature spaces in accordance with some embodiments. Method 500 may be executed on a computing device featuring one or more processors (e.g., SOC 100, processors 110, 112, 114, 116, 118, 121, 122, etc.). These processors, along with other hardware, software, firmware, etc., may form a processing system capable of carrying out the operations detailed in methods 500.

In block 502, the processing system may store or access a feature space representation corresponding to a multi-dimensional database, an original query that includes initial query intervals, a predefined sensitivity threshold for a minimum acceptable record count, and weights corresponding to the importance of individual features in the feature space. In block 504, the processing system may perform the original query on the feature space to retrieve records. In block 506, the processing system may count the number of retrieved records. In block 508, the processing system may compare the counted number of records to the sensitivity threshold. In some embodiments, the processing system may terminate method 500 if the counted number of records meets or surpasses the sensitivity threshold.

In block 510, the processing system may initialize a loss function in response to determining that the counted number of records does not meet or surpass the sensitivity threshold. In some embodiments, the processing system may initialize the loss function based on at least one of the following equations:

$$L = {Σ}_{i} {w}_{i} Δ {X}_{i}$$

$$L = Π [ {( {X}_{i} + Δ {X}_{i} )}^{n} - {X}_{i}^{n} ] or$$

$$L = Π [ {( {X}_{i} + {w}_{i} Δ {X}_{i} )}^{n} - {X}_{i}^{n} ]$$

In block 512, the processing system may perform a query optimization loop (or “query relaxation and optimization loop”) in which the processing system iteratively traverses each feature in the feature space, determines permissible ΔXi values for each feature, determines a new loss value based on the loss function for the determined ΔXi values, determines whether the new loss value is minimized while still meeting the sensitivity threshold, and updates a solution set and the counted number of records based on the evaluation.

In optional block 514, the processing system may update the weights to adjust feature importance and re-run the query optimization loop in block 512. In block 516, the processing system may select and apply an optimization method to generate a minimized loss value. In block 518, the processing system may use the generated minimized loss value to evaluate a final solution set. In block 520, the processing system may return a modified query or a dataset that satisfies the sensitivity threshold with the minimized loss value.

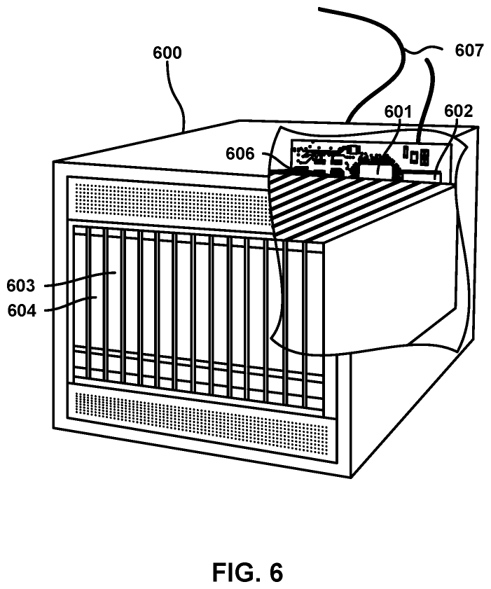

Some embodiments may be implemented on any of a variety of commercially available computing devices, such as the server computing device 600 illustrated in FIG. 6. Such a server device 600 may include a processor 601 coupled to volatile memory 602 and a large capacity nonvolatile memory, such as a disk drive 603. The server device 600 may also include a floppy disc drive, USB, etc. coupled to the processor 601. The server device 600 may also include network access ports 606 coupled to the processor 601 for establishing data connections with a network connection circuit 604 and a communication network 607 (e.g., an Internet protocol (IP) network) coupled to other communication system network elements.

The processors or processing units discussed in this application may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within a second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured (e.g., with processor-executable instructions) to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1: A method of using artificial intelligence (AI) to make decisions or predictions without direct human intervention, the method including receiving an input query that includes query parameters and auxiliary data, applying the received input query to an AI model to generate an initial prediction, performing explainable AI (XAI) analysis using approximate methods to identify influential features, determining key features based on the identified influential features, applying the determined key features to a modified counterfactual model to generate an initial set of counterfactuals, prioritizing the generated initial set of counterfactuals, determining whether the prioritized set of counterfactuals has reached convergence, and outputting an enhanced set of counterfactuals in response to determining that the prioritized set of counterfactuals has reached convergence.

Example 2: The method of example 1, further including performing validation analysis on the query parameters to determine conformance to a standard or constraint or to ensure that the input query and its subsequent results follow predefined validation rules and guidelines.

Example 3: The method of any of the examples 1 and 2, further includes performing validating the prioritized set of counterfactuals to determine conformance to a standard or constraint or to ensure that the prioritized set of counterfactuals follow predefined validation rules and guidelines.

Example 4: The method of any of the examples 1-3, in which performing XAI analysis using approximate methods to identify influential features includes creating a new dataset by perturbing features of the generated initial predictions that need to be explained, using a trained machine learning model to make predictions on the perturbed samples, assigning weights to the perturbed samples based on their similarity to the generated initial predictions, and apply a linear regression model to the perturbed samples using the assigned weights.

Example 5: The method of any of the examples 1-4, in which applying the determined key features to a modified counterfactual model to generate the initial set of counterfactuals includes applying the determined key features to a counterfactual model with relaxed sparsity to generate the initial set of counterfactuals.

Example 6: The method of any of the examples 1-5, in which applying the determined key features to a modified counterfactual model to generate the initial set of counterfactuals includes applying the determined key features to the modified counterfactual algorithm to identify alternative less-sensitive queries and generate a list of alternative queries that are compliant with California Consumer Privacy Act (CCPA) or General Data Protection Regulation (GDPR).

Example 7: The method of any of the examples 1-6, in which applying the determined key features to a modified counterfactual model to generate the initial set of counterfactuals includes applying the determined key features to the modified counterfactual algorithm to generate counterfactuals with different combinations of categorical data types.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different types of memories and memory technologies are available or contemplated in the future, any or all of which may be included and used in systems and computing devices that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudostatic random-access memory (PSRAM). Systems and computing devices that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in a computing device, system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general-purpose processor, a digital signal processor (DSP), an application-specific integrated circuit (TCUASIC), a field programmable gate array (FPGA) or other programmable logic devices, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store target program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of using artificial intelligence (AI) to make decisions or predictions without direct human intervention, the method comprising:
receiving an input query that includes query parameters and auxiliary data;
applying the received input query to an AI model to generate an initial prediction;
performing explainable AI (XAI) analysis using approximate methods to identify influential features;
determining key features based on the identified influential features;
applying the determined key features to a modified counterfactual model to generate an initial set of counterfactuals;
prioritizing the generated initial set of counterfactuals;
determining whether the prioritized set of counterfactuals has reached convergence; and
outputting an enhanced set of counterfactuals in response to determining that the prioritized set of counterfactuals has reached convergence.

2. The method of claim 1, further comprising performing validation analysis on the query parameters to determine conformance to a standard or constraint or to ensure that the input query and its subsequent results follow predefined validation rules and guidelines.

3. The method of claim 1, further comprising validating the prioritized set of counterfactuals to determine conformance to a standard or constraint or to ensure that the prioritized set of counterfactuals follow predefined validation rules and guidelines.

4. The method of claim 1, wherein performing XAI analysis using approximate methods to identify influential features comprises:
creating a new dataset by perturbing features of the generated initial predictions that need to be explained;
using a trained AI model to make predictions on the perturbed samples;
assigning weights to the perturbed samples based on their similarity to the generated initial predictions; and
apply a linear regression model to the perturbed samples using the assigned weights.

5. The method of claim 1, wherein applying the determined key features to a modified counterfactual model to generate the initial set of counterfactuals comprises applying the determined key features to a counterfactual model with relaxed sparsity to generate the initial set of counterfactuals.

6. The method of claim 1, wherein applying the determined key features to a modified counterfactual model to generate the initial set of counterfactuals comprises applying the determined key features to the modified counterfactual algorithm to identify alternative less-sensitive queries and generate a list of alternative queries that are compliant with California Consumer Privacy Act (CCPA) or General Data Protection Regulation (GDPR).

7. The method of claim 1, wherein applying the determined key features to a modified counterfactual model to generate the initial set of counterfactuals comprises applying the determined key features to the modified counterfactual algorithm to generate counterfactuals with different combinations of categorical data types.

8. A computing device, comprising:
a processing system that includes at least one processor and is configured to:
receive an input query that includes query parameters and auxiliary data;
apply the received input query to an artificial intelligence (AI) model to generate an initial prediction;
perform explainable AI (XAI) analysis using approximate methods to identify influential features;
determine key features based on the identified influential features;
apply the determined key features to a modified counterfactual model to generate an initial set of counterfactuals;
prioritize the generated initial set of counterfactuals;
determine whether the prioritized set of counterfactuals has reached convergence; and
output an enhanced set of counterfactuals in response to determining that the prioritized set of counterfactuals has reached convergence.

9. The computing device of claim 8, wherein the processing system is further configured to perform validation analysis on the query parameters to determine conformance to a standard or constraint or to ensure that the input query and its subsequent results follow predefined validation rules and guidelines.

10. The computing device of claim 8, wherein the processing system is further configured to validate the prioritized set of counterfactuals to determine conformance to a standard or constraint or to ensure that the prioritized set of counterfactuals follows predefined validation rules and guidelines.

11. The computing device of claim 8, wherein the processing system is configured to perform the XAI analysis using the approximate methods to identify the influential features by:
creating a new dataset by perturbing features of the generated initial predictions that need to be explained;
using a trained AI model to make predictions on the perturbed samples;
assigning weights to the perturbed samples based on their similarity to the generated initial predictions; and
apply a linear regression model to the perturbed samples using the assigned weights.

12. The computing device of claim 8, wherein the processing system is configured to apply the determined key features to a modified counterfactual model to generate the initial set of counterfactuals by applying the determined key features to a counterfactual model with relaxed sparsity to generate the initial set of counterfactuals.

13. The computing device of claim 8, wherein the processing system is configured to apply the determined key features to a modified counterfactual model to generate the initial set of counterfactuals by applying the determined key features to the modified counterfactual algorithm to identify alternative less-sensitive queries and generate a list of alternative queries that are compliant with California Consumer Privacy Act (CCPA) or General Data Protection Regulation (GDPR).

14. The computing device of claim 8, wherein the processing system is configured to apply the determined key features to a modified counterfactual model to generate the initial set of counterfactuals by applying the determined key features to the modified counterfactual algorithm to generate counterfactuals with different combinations of categorical data types.

15. A non-transitory processor readable media having stored thereon processor-executable instructions configured to cause a processing system that includes at least one processor in a computing device to perform operations comprising:
receiving an input query that includes query parameters and auxiliary data;
applying the received input query to an artificial intelligence (AI) model to generate an initial prediction;
performing explainable AI (XAI) analysis using approximate methods to identify influential features;
determining key features based on the identified influential features;
applying the determined key features to a modified counterfactual model to generate an initial set of counterfactuals;
prioritizing the generated initial set of counterfactuals;
determining whether the prioritized set of counterfactuals has reached convergence; and
outputting an enhanced set of counterfactuals in response to determining that the prioritized set of counterfactuals has reached convergence.

16. The non-transitory processor readable media of claim 15, wherein the stored processor-executable instructions are configured to cause the processing system to perform operations further comprising performing validation analysis on the query parameters to determine conformance to a standard or constraint or to ensure that the input query and its subsequent results follow predefined validation rules and guidelines.

17. The non-transitory processor readable media of claim 15, wherein the stored processor-executable instructions are configured to cause the processing system to perform operations further comprising performing validating the prioritized set of counterfactuals to determine conformance to a standard or constraint or to ensure that the prioritized set of counterfactuals follow predefined validation rules and guidelines.

18. The non-transitory processor readable media of claim 15, wherein the stored processor-executable instructions are configured to cause the processing system to perform operations such that performing XAI analysis using approximate methods to identify influential features comprises:
creating a new dataset by perturbing features of the generated initial predictions that need to be explained;
using a trained AI model to make predictions on the perturbed samples;
assigning weights to the perturbed samples based on their similarity to the generated initial predictions; and
apply a linear regression model to the perturbed samples using the assigned weights.

19. The non-transitory processor readable media of claim 15, wherein the stored processor-executable instructions are configured to cause the processing system to perform operations such that applying the determined key features to a modified counterfactual model to generate the initial set of counterfactuals comprises applying the determined key features to a counterfactual model with relaxed sparsity to generate the initial set of counterfactuals.

20. The non-transitory processor readable media of claim 15, wherein the stored processor-executable instructions are configured to cause the processing system to perform operations such that applying the determined key features to a modified counterfactual model to generate the initial set of counterfactuals comprises applying the determined key features to the modified counterfactual algorithm to identify alternative less-sensitive queries and generate a list of alternative queries that are compliant with California Consumer Privacy Act (CCPA) or General Data Protection Regulation (GDPR).

21. The non-transitory processor readable media of claim 15, wherein the stored processor-executable instructions are configured to cause the processing system to perform operations such that applying the determined key features to a modified counterfactual model to generate the initial set of counterfactuals comprises applying the determined key features to the modified counterfactual algorithm to generate counterfactuals with different combinations of categorical data types.
